(19) United States
(12) Patent Application Publication
(10) Pub. No.: US 2018/0188166 A1
(43) Pub. Date: Jul. 5, 2018

(54) Air Crew Breathing Air Quality Monitoring System

(71) Applicant: Texas Research International, Inc., Austin, TX (US)

(72) Inventors: Frank Thomas Zeller, Dripping Springs, TX (US); George Phillip Hansen, Austin, TX (US); Ajay Rasik Shah, Austin, TX (US)

(21) Appl. No.: 15/800,236

(22) Filed: Nov. 1, 2017

Related U.S. Application Data
(60) Provisional application No. 62/417,297, filed on Nov. 3, 2016.

(51) Int. Cl. G01N 21/39; B64D 45/00; B64F 5/60; G08B 21/12

(52) U.S. Cl. CPC G01N 21/39; B64D 45/00; G01N 21/3504; G08B 21/12; B64F 5/60

(57) ABSTRACT

A compact system and method that makes use of a laser based gas detection to monitor aircraft breathing air. The basic principle of the analytical method to be utilized involves measurements of the amount of infrared light (IR) absorbed by the breathing air and contaminants in the air, each which has a unique fingerprint.

### CROSS REFERENCE TO RELATED APPLICATIONS

This application claims the benefit of U.S. application Ser. No. 62/417,297 filed Nov. 3, 2016.

### STATEMENT OF RIGHTS TO INVENTION MADE UNDER FEDERALLY SPONSORED RESEARCH

This invention was made with government support under the Small Business Innovative Research (SBIR) Program, Topic Number AF151-023 contract number FA8650-15-M-6649 awarded by the USAF/AFMC AFRL Wright Research Site. The government has certain rights in the invention.

The success of any mission utilizing high performance defense aircraft pivots on the aircrew's mental acuity and physical condition. Split-second-decision-making capacity, high gravity load tolerance, and protracted endurance are among the demands placed on these crewmen by every flight excursion. Maintenance of these important physical factors and pilot endurance through flight challenges depend in turn on breathing air quality provided to crew while in flight. To maintain optimal oxygen concentration and pressure to the crew in all maneuvers at altitude aircraft are equipped with an onboard oxygen generating system (OBOGS) that utilizes compressed engine bleed air to supply oxygen, and pressure swing adsorption (PSA) technology to maintain cabin pressure. These are components of the aircraft environmental control systems (ECS) and life support systems (LSS). In addition aircraft are also equipped with back-up stored oxygen supply systems for use in emergencies.

There is a need then for a multi-modal sensor system to monitor aircraft breathing air composition and detect contaminants therein during flight operations.

### BRIEF SUMMARY OF THE CONCEPT

The aforementioned need can be met by a compact system that makes use of a laser based gas detection to monitor aircrew breathing air. The basic principle of the analytical method to be utilized involves measurements of the amount of infrared light (IR) absorbed by the breathing air and contaminants in the air, each which has a unique fingerprint.

### BRIEF DESCRIPTION OF THE DRAWINGS

FIG. 1 illustrates the nature of the oxygen concentration levels need by aircrew members at various altitudes.

FIG. 2 illustrates the pilot breathing air path and cockpit air supply from the life support system (LSS).

FIG. 3 illustrates how commercial aircraft cabin air is frequently supplied from the aft-most engine compressor stage. The only exception to this approach is in the Boeing 787, which uses “bleed free” technology.

FIG. 4 illustrates the potential excellent resolution possible in a typical IR spectrum obtained from foundry gases.

FIG. 5 illustrates a schematic configuration of the quantum cascade vertical cavity surface emitting laser.

FIG. 6 illustrates a basic schematic of the laser measurement system of this proposal.

FIG. 7A illustrates transmittance spectra obtained by QCL VCSEL techniques.

FIG. 7B illustrates transmittance spectra obtained by FTIR techniques.

### DETAILED DESCRIPTION

In the following detailed description, reference is made to accompanying drawings that illustrate embodiments of the present disclosure. These embodiments are described in sufficient detail to enable a person of ordinary skill in the art to practice the disclosure without undue experimentation. It should be understood, however, that the embodiments and examples described herein are given by way of illustration only, and not by way of limitation. Various substitutions, modifications, additions, and rearrangements may be made without departing from the spirit of the present disclosure. Therefore, the description that follows is not to be taken in a limited sense, and the scope of the present disclosure will be defined only by the final claims.

The success of any mission utilizing high performance defense aircraft pivots on the air crew's mental acuity and physical condition. Split-second-decision-making capacity, high gravity load tolerance, and protracted endurance are among the demands placed on these crewmen by every flight excursion. Maintenance of these important physical factors and pilot endurance through flight challenges depend in turn on breathing air quality provided to crew while in flight. To maintain optimal oxygen concentration and pressure to the crew in all maneuvers at altitude, aircraft are equipped with an onboard oxygen generating system (OBOGS), which utilizes compressed engine bleed air to supply oxygen, and pressure swing adsorption (PSA) technology to maintain cabin pressure. These are components of the aircraft environmental control systems (ECS) and life support systems (LSS). In addition, aircraft are also equipped with back-up stored oxygen supply systems for use in emergencies.

Pressure swing adsorption (PSA) technology is based on the principle that gases under pressure are generally attracted to solid surfaces upon which the gases are adsorbed. Higher pressure results in greater gas adsorption. When the pressure is reduced or swings from high to low, gas is released or desorbed. Gaseous mixtures may be separated through pressure swing adsorption (PSA) because different gases tend to be adsorbed or attracted to different solid materials to varying degrees. Accordingly, when the pressure is reduced gases that are less strongly attracted to the solid materials will be desorbed first to form an outlet stream. After the bed of solid material to which gases are adsorbed reaches its capacity to adsorb, pressure is further reduced to release even the more strongly attracted gases. As applied to an on-board oxygen generator (OBOG), engine bleed air is typically fed into the pressure swing adsorption (PSA) device, the nitrogen component of air is adsorbed to a bed of solid material more strongly than the oxygen component of air, and an outlet stream of enriched oxygen is produced. This is similar to the process used in portable oxygen concentrators for emphysema patients and others who require oxygen enriched air to breathe.

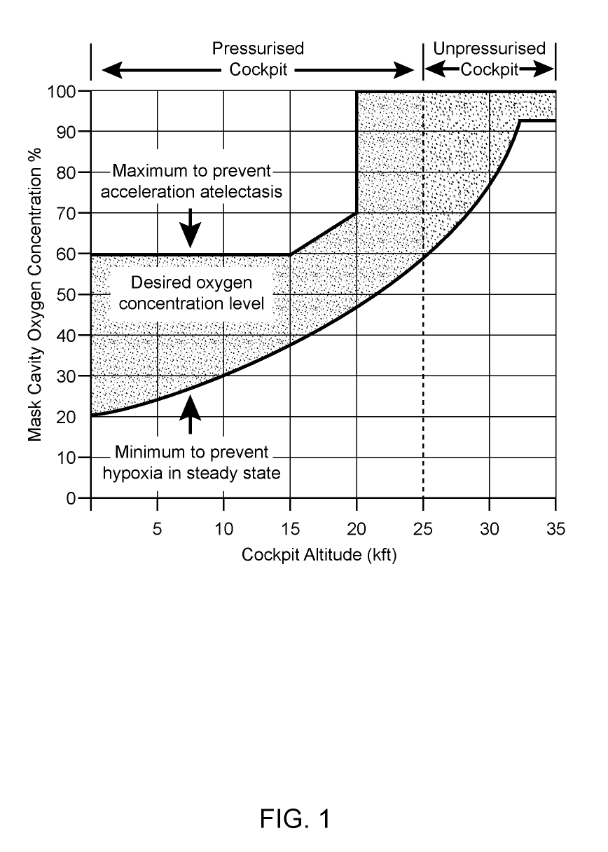

FIG. 1 illustrates the range of mask cavity oxygen concentrations that an aircraft's ECS and LSS attempt to maintain at different altitudes. The sensor system proposed herein must complement, and not interfere with these systems.

Bleed air from the ninth-stage of the engine's compressor, or from the auxiliary power unit (APU) on the ground are the original sources of the breathing air. The bleed air is conditioned to the proper pressure (35 pounds per square inch (psi)), temperature, and humidity by heat exchangers that use either air or a polyalphaolefin synthetic lubricant as a coolant. The Air Cycle Machine (ACM) prioritizes the bleed air flow to Life Support and Avionics cooling. Bleed air entering the OBOGS unit is assumed to be breathable (i.e., free of harmful contaminants), as the air handling and coolant systems are each self-contained with the contents of each never coming into direct contact with the other.

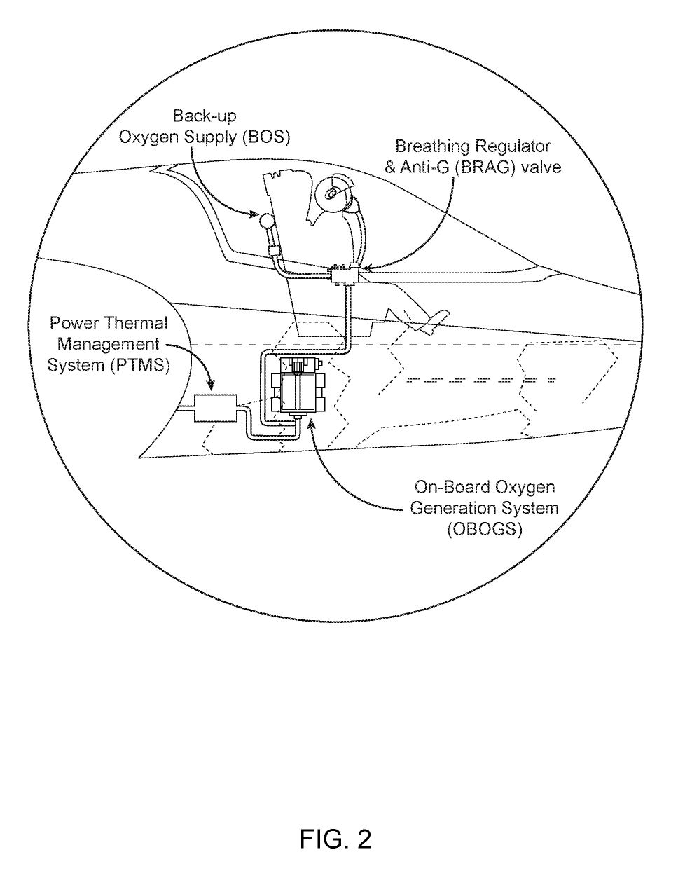

FIG. 2 illustrates pilot breathing air path and cockpit air supply from the life support system (LSS). The proposed air crew breathing air monitoring system can tap into the flow of oxygen to the crew to monitor for the key contaminants of interest.

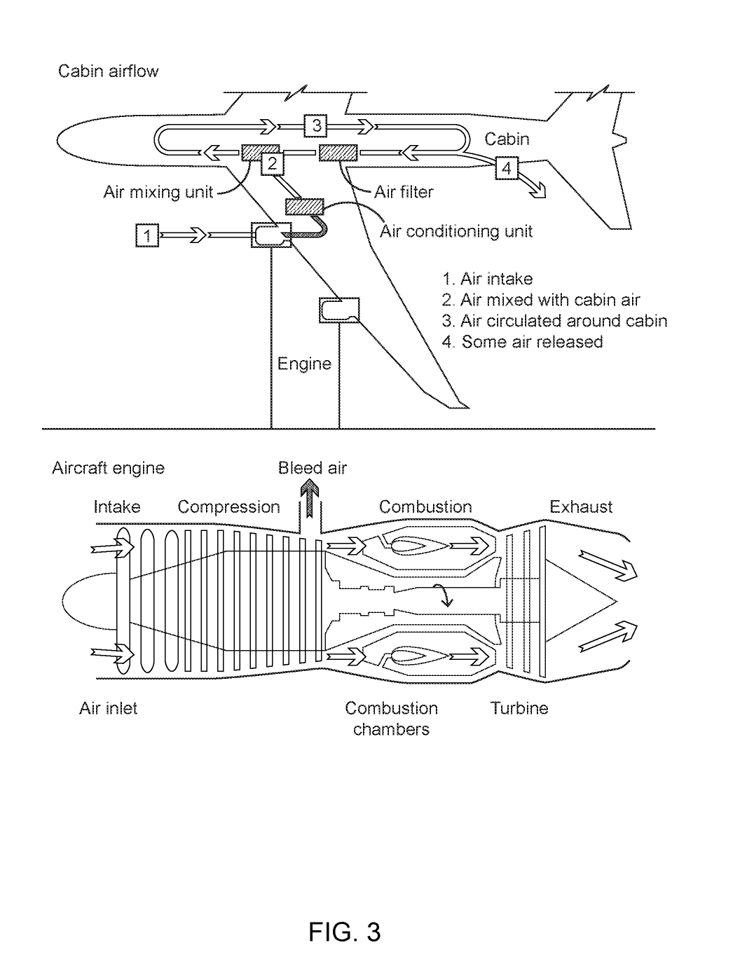

Air quality on commercial aircraft is a potential widespread issue for the general civilian population. FIG. 3 shows similarities and differences to the breathing air system on defense aircraft. As a result of continued concerns about commercial aircraft cabin air quality and health issues raised by cabin crew and passengers, in 2000 Congress directed Federal Aviation Administration (FAA) to request the National Research Council (NRC) to perform an independent study to examine cabin air quality. The NRC convened a Committee on Air Quality in Passenger Cabins of Commercial Aircraft which reported its findings to FAA in 2002. Its most relevant recommendation suggested only that airlines “continuously monitor and record O₃, CO, CO₂, fine particles, cabin pressure, temperature, and relative humidity.” Adverse central nervous system reactions to airborne contaminants surely requires a more comprehensive, if not at least more substantial, list of potential chemical vapors to be monitored in cabin air.

The OBOGS unit uses micro porous zeolite, a natural or synthetic aluminosilicate mineral, to selectively filter nitrogen and other gaseous contaminants, thereby providing oxygen-enriched breathing gas on a schedule associated with aircraft altitude. This subsystem compensates for the decrease in oxygen partial pressure with altitude and protects the pilot against rapid decompression.

Under suboptimal operating conditions, toxic contaminants have been found to enter the aircrew's breathing air system. A series of incidents where pilots experienced breathing difficulty, disorientation, confusion, and headache were traced to the air supply, but no clearly attributable causes were further identified. These unresolved incidents led to grounding the entire F-22 fleet for nearly five months in 2011. Though the bleed air is taken upstream of the combustion zone on that aircraft, the OBOGS design was considered fundamentally vulnerable to ingestion of jet exhaust and airborne contaminants from other nearby aircraft, and under suboptimal operating conditions, toxic byproducts of these could have breached the OBOGS and contaminate the crew's oxygen supply. It also possible that the contamination entered the air stream after the OBOGS, since a number of investigators have thought the contaminants detected at the aircrew masks should have been stopped by the 13× zeolite oxygen filter in the OBOGS.

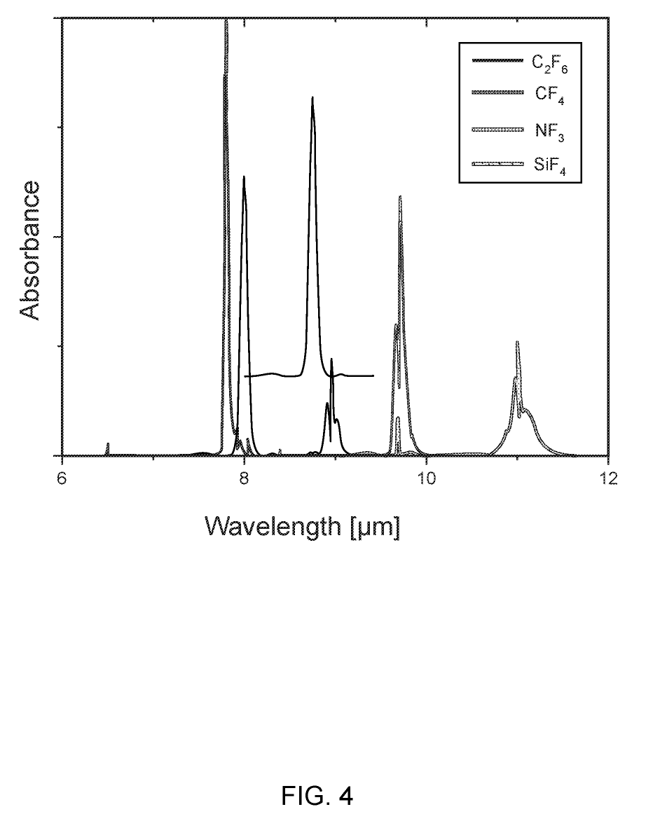

The ability to resolve, identify and monitor actual levels in mixtures of gases is illustrated in FIG. 4, wherein the gases used in a semiconductor foundry appear as distinct spectral features. The small size of the system to be developed will allow its widespread installation in air handling systems of plants and buildings and in industrial equipment which utilize processes involving gas-phase chemistry to produce any number of products and materials. Strategic placement of the system can assist in monitoring escaping pollutants in the part per million range, allowing for extremely sensitive detection of environmental toxins.

An extensive, multi-step, multi-disciplinary investigation was undertaken by personnel from the USAF, Boeing, Lockheed Martin, and others to identify chemicals that might possibly enter a pilot's breathing air on the F-22 and account for acute central nervous system (CNS) effects. The process, termed the Molecular Characterization Matrix (MCM), began with the generation of a list of chemicals known to be present in jet fuel, jet oil, and hydraulic fluids used on the aircraft, together with selected chemical compounds believed to be associated with pyrolysis or degeneration of these petroleum products. The focus was on chemicals, gases, or aerosols whose presence in life support system (LSS) air was considered plausible by virtue of normal operation of the jet engine, or from leaks in seals, valves, or other conduits. By January of 2012, 759 chemical compounds associated with the aircraft had been assessed. A team of toxicologists and occupational health professionals narrowed this to 208 chemicals previously shown to exert acute adverse effects on the CNS in human or experimental animal studies. To date, 126 chemicals in this subset have been detected in aircraft environmental control systems (ECS) air samples from ground and flight tests of the aircraft. A design mitigation being implemented involves integration of an oxidizing catalyst subsystem to eliminate these toxins.

Though these investigations did not specifically identify any likely contaminants, ensembles thereof, or imbalance in breathing air composition as root causes in the reported cases, they did identify four gases, CO, CO₂, O₃, Ar and tricresyl phosphate (TCP), as “as possible causes of various respiratory and CNS-type symptoms experienced by F-22 Raptor air and ground crew,” and identified a gap with respect to general cognizance of pilots' air supply quality, cockpit environments and conditions, and effects of these on aircrew. This gap led to the acknowledged need for development of an orthogonal, in-flight sensor suite enabling continuous assessment of pilot air quality conditions. Real-time detection of breathing air composition and potential contaminants would allow investigators to determine if, when and how these contribute to future incidents and aid in identification and mitigation of their sources. Such a suite would also be valuable for assessments of OBOGS operational efficiencies.

We are proposing that a technology that can address this simultaneous need for reliably identifying multiple contaminant gases and to do it in a subsystem that can be integrated into the size and weight restrains of military fighters as well as commercial aviation is the use of an analytical method involving measurements of the amount of infrared light (IR) absorbed by the breathing air and contaminants in the air. The natural components of air (i.e., nitrogen, oxygen, carbon dioxide, water etc.) each absorbs light at characteristic frequencies that can be used to fingerprint their presence and concentration in the air. This is also true of contaminant vapors in the air. Each has its own unique fingerprint. In all cases, the amount of light absorbed at a particular wavelength characteristic of the vapor species is proportional to the amount of substance present in the gas cell of the spectrometer. Light at a known frequency and intensity is passed through a cell containing the mixture of air and contaminants. The measured amount of this light at particular characteristic frequencies that ultimately impinges on the detector “downstream” indicates the presence and amount present of each chemical species in the air mixture.

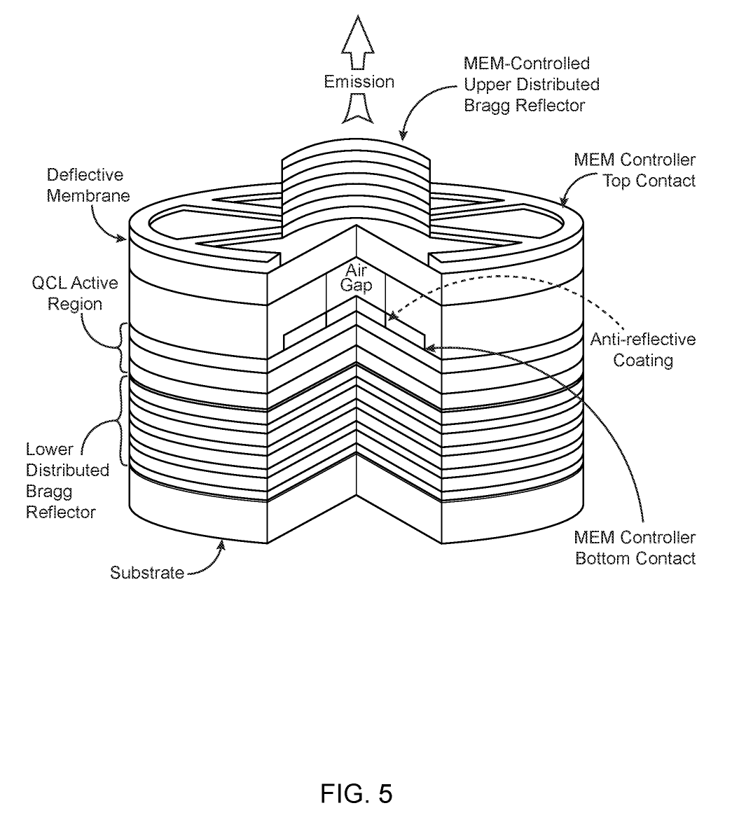

The proposed subsystem is based on the emergence of asymmetric quantum well super lattices of InGaAs or AlGaAs imbedded in vertical cavity surface emitting lasers (VCSEL), which provide the spectral light source for the system. A schematic configuration of the quantum cascade vertical surface emitting laser is illustrated in FIG. 5. Wavelength of the light emitted is controlled by a micro-electro-mechanical (MEM) assembly which changes the relative position of the upper distributed Bragg reflector (DBR). By changing the position of this DBR, the wavelength passed by the upper reflecting surface of the laser is scanned though the spectrum. Thus, only changes in device input voltage is necessary to scan the laser through the spectral range; and with these tunable components, it is not necessary to subsequently diffract the light into individual wavelengths to obtain an absorption or transmission spectrum, nor is it necessary to maintain an absorption reference cell.

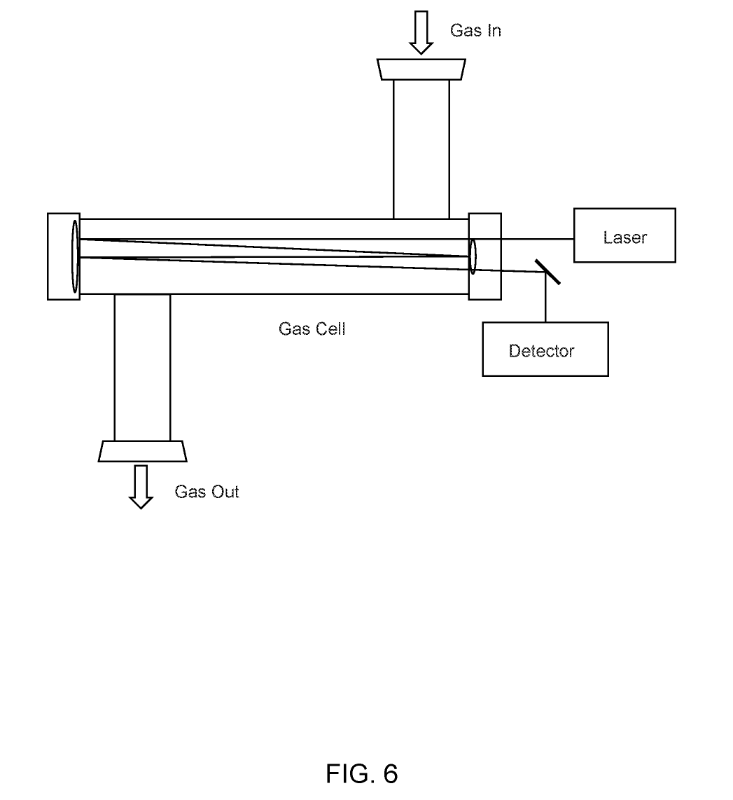

A key element for measurement of very low levels of contaminants is a configuration that can pass the laser light through an extended path of breathing air. A basic configuration of a spectrometer that can do this is shown in FIG. 6, which is a basic schematic illustrating breathing air entering (Gas In) and passing through a cell before exiting (Gas Out) with a laser light passing through the breathing air. In this example, the light passes through the breathing air three times. This results in a simplicity that can reduce cost footprint and weight, while increasing system reliability by having fewer components.

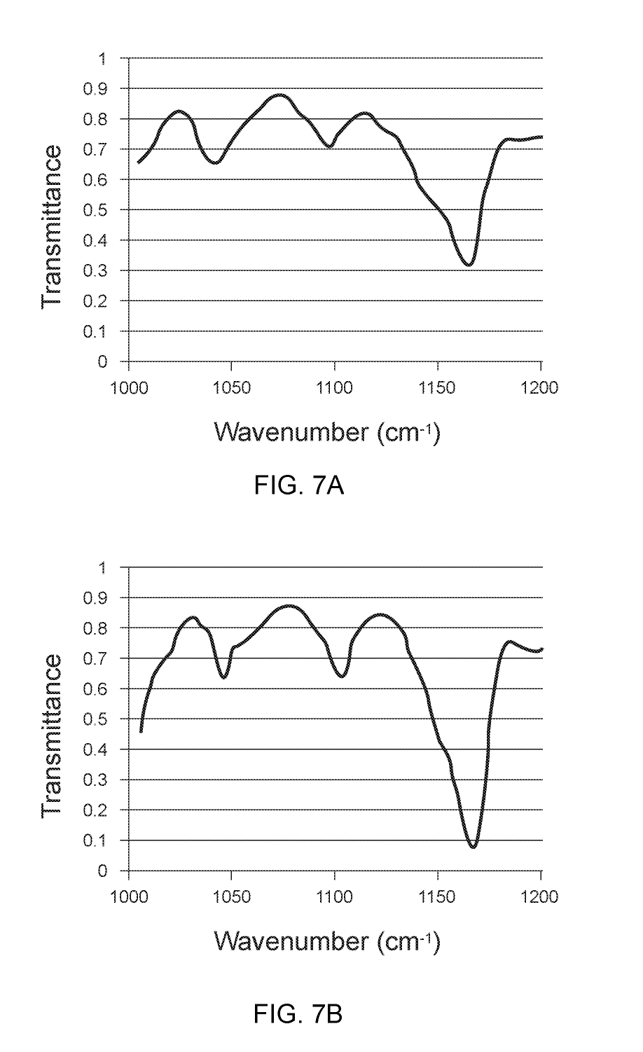

In alternate embodiments the proposed laser system can be configured with up to 3 tunable laser modules that cover approximately 250 cm⁻¹ each. This offers a gap-free tuning wavelength range between 5.4 and 12.8 μm (1850−780 cm⁻¹) with 2 cm⁻¹ typical of the spectral line width. Spectral accuracy or repeatability is less than 2 cm⁻¹, more typically less than 0.5 cm⁻¹, wavelength repeatability is better than 0.1 cm⁻¹, power variation is less than 0.05% over 10 ms, and beam divergence is better than 5 mrad. Including more lasers to broaden the spectral range of the system is currently possible, though this requires custom engineering of the optics and is not routine but thoroughly feasible. The laser power and efficiency achieved to date allow significantly greater signal to noise than Fourier transform infrared spectroscopy (FTIR). Also, with the spectral scan rates being limited only by the rate of response of the MEM actuator on the upper distributed Bragg reflector, incredibly fast spectral repetition rates are currently achievable. In FIGS. 7A and 7B we show spectra obtained by QCL VCSEL and FTIR side-by-side to allow comparison of the resolving power of the two methods.

To ensure accuracy of contaminant detection and identification the system to be developed will have stored on-board a library of the spectral fingerprints of normal breathing air components as well as those of critical organic compounds. In addition, the spectral response of the system to concentration of each contaminant will be stored in the library in order to obtain concentration measurements of these compounds as they appear in the OBOGS. Thus, the recorded output of the system will be a time-log registry of the measured compound concentrations over the time period of each sortie. In addition, should a contaminant appear that is not pre-recorded in the library, the spectral scans can be recorded for subsequent investigation and analysis for identification. In addition to being instrumentally robust, the system to be developed will be environmentally rugged in order to tolerate the conditions of the F-35 cockpit.

The resulting subsystem can be integrated into the ECS and OBOGS systems and provide accurate detailed information on contaminants.

Although certain embodiments and their advantages have been described herein in detail, it should be understood that various changes, substitutions and alterations could be made without departing from the coverage as defined by the appended claims. Moreover, the potential applications of the disclosed techniques is not intended to be limited to the particular embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized. Accordingly, the appended claims are intended to include within their scope such processes, machines, manufactures, means, methods or steps.

1. A laser based gas detection system for real-time monitoring of contaminants in aircraft breathing air systems integrated into on-board oxygen generating systems of the aircraft comprising:
a. a quantum cascade vertical cavity surface emitting laser system utilizing embedded asymmetric quantum super lattices of InGaAs or AlGaAs;
b. a laser resonator within the vertical cavity surface emitting laser system comprising upper and lower distributed Bragg reflectors;
c. a spectrophotometer detector system for passing the laser light from the vertical cavity surface emitting laser system through an extended path of breathing air from the on-board oxygen generating systems multiple times before striking a detector to aid in detecting low levels of contaminants;
d. a micro-electro-mechanical (MEM) assembly that changes the relative position of the upper distributed Bragg reflector in order to scan the wavelength passed by an upper reflecting surface of the laser through a spectrum of wavelengths;
e. an on-board stored library of the spectral components of normal breathing air components as well as critical organic compounds that could possibly contaminate aircraft breathing systems; the on-board stored library to also include the spectral response of the system to a concentration of each contaminant.

2. The laser based gas detection system for real-time monitoring of contaminants in aircraft breathing air systems integrated into on-board oxygen generating systems of the aircraft of claim 1 wherein the on-board oxygen generating system utilizes compressed aircraft engine bleed air and pressure swing adsorption (PSA) technology to maintain cabin pressure.

3. The laser based gas detection system for real-time monitoring of contaminants in aircraft breathing air systems integrated into on-board oxygen generating systems of the aircraft of claim 1 wherein the on-board oxygen generating system is supplied via a back-up stored oxygen supply.

4. The laser based gas detection system for real-time monitoring of contaminants in aircraft breathing air systems integrated into on-board oxygen generating systems of the aircraft of claim 1 wherein the spectrophotometer detector system for passing the laser light from the vertical cavity surface emitting laser system through an extended path of breathing air from the on-board oxygen generating systems passes the laser light through the extended path of breathing air from the on-board oxygen generating systems three times before striking the detector.

5. The laser based gas detection system for real-time monitoring of contaminants in aircraft breathing air systems integrated into on-board oxygen generating systems of the aircraft of claim 1 wherein the quantum cascade vertical cavity surface emitting laser system is configured with multiple laser modules that cover approximately 250 cm⁻¹ each.

6. The laser based gas detection system for real-time monitoring of contaminants in aircraft breathing air systems integrated into on-board oxygen generating systems of the aircraft of claim 1 wherein the aircraft is a military aircraft and the breathing air is provided to the aircrew.

7. The laser based gas detection system for real-time monitoring of contaminants in aircraft breathing air systems integrated into on-board oxygen generating systems of the aircraft of claim 1 wherein the aircraft is a commercial aircraft and the breathing air is provided to the aircrew and to passengers.

8. The laser based gas detection system for real-time monitoring of contaminants in aircraft breathing air systems integrated into on-board oxygen generating systems of the aircraft of claim 1 wherein the detection of any significant contaminants is reported to the aircrew via an alarm system.

9. A method of laser based gas detection system for real-time monitoring of contaminants in aircraft breathing air systems integrated into on-board oxygen generating systems of the aircraft comprising:
a. providing a quantum cascade vertical cavity surface emitting laser system utilizing embedded asymmetric quantum super lattices of InGaAs or AlGaAs;
b. providing a laser resonator within the vertical cavity surface emitting laser system comprising upper and lower distributed Bragg reflectors;
c. providing a spectrophotometer detector system for passing the laser light from the vertical cavity surface emitting laser system through an extended path of breathing air from the on-board oxygen generating systems multiple times before striking a detector to aid in detecting low levels of contaminants;
d. providing a micro-electro-mechanical (MEM) assembly that changes the relative position of the upper distributed Bragg reflector in order to scan the wavelength passed by an upper reflecting surface of the laser through a spectrum of wavelengths;
e. providing an on-board stored library of the spectral components of normal breathing air components as well as critical organic compounds that could possibly contaminate aircraft breathing systems; the on-board stored library to also include the spectral response of the system to a concentration of each contaminant.

10. The method of laser based gas detection system for real-time monitoring of contaminants in aircraft breathing air systems integrated into on-board oxygen generating systems of the aircraft of claim 9 wherein the on-board oxygen generating system utilizes compressed aircraft engine bleed air and pressure swing adsorption (PSA) technology to maintain cabin pressure.

11. The method of laser based gas detection system for real-time monitoring of contaminants in aircraft breathing air systems integrated into on-board oxygen generating systems of the aircraft of claim 9 wherein the on-board oxygen generating system is supplied via a back-up stored oxygen supply.

12. The method of laser based gas detection system for real-time monitoring of contaminants in aircraft breathing air systems integrated into on-board oxygen generating systems of the aircraft of claim 9 wherein the spectrophotometer detector system for passing the laser light from the vertical cavity surface emitting laser system through an extended path of breathing air from the on-board oxygen generating systems passes the laser light through the extended path of breathing air from the on-board oxygen generating systems three times before striking the detector.

13. The method of laser based gas detection system for real-time monitoring of contaminants in aircraft breathing air systems integrated into on-board oxygen generating systems of the aircraft of claim 9 wherein the quantum cascade vertical cavity surface emitting laser system is configured with multiple laser modules that cover approximately 250 cm⁻¹ each.

14. The method of laser based gas detection system for real-time monitoring of contaminants in aircraft breathing air systems integrated into on-board oxygen generating systems of the aircraft of claim 9 wherein the aircraft is a military aircraft and the breathing air is provided to the aircrew.

15. The method of laser based gas detection system for real-time monitoring of contaminants in aircraft breathing air systems integrated into on-board oxygen generating systems of the aircraft of claim 9 wherein the aircraft is a commercial aircraft and the breathing air is provided to the aircrew and to passengers.

16. The method of laser based gas detection system for real-time monitoring of contaminants in aircraft breathing air systems integrated into on-board oxygen generating systems of the aircraft of claim 9 wherein the detection of any significant contaminants is reported to the aircrew via an alarm system.
